(19) United States
(12) Patent Application Publication
(10) Pub. No.: US 2024/0141218 A1
(43) Pub. Date: May 2, 2024

(54) MASTIC FOR EXTREME WEATHER CONDITIONS IN TERMS OF TEMPERATURE AND HUMIDITY

(71) Applicant: BOSTIK SA, COLOMBES (FR)

(72) Inventor: David JUSSY, Venette (FR)

(21) Appl. No.: 18/277,986

(22) PCT Filed: Feb. 24, 2022
(86) PCT No.: PCT/FR2022/050341

§ 371 Date: Aug. 19, 2023

(30) Foreign Application Priority Data
Feb. 25, 2021 (FR) FR2101825

(51) Int. Cl. C09J 175/08; C09J 11/04

(52) U.S. Cl. CPC C09J 175/08; C09J 11/04

(57) ABSTRACT

1) A sealant composition comprising:
from 20% to 45% by weight of a silyl polymer (A);
from 30% to 55% by weight of a filler (B); and
from 0.05% to 5% by weight of an antioxidant composition (C) consisting, on the basis of the total number of moles of the compounds present in the composition (C), of 20 to 100 mol % of a secondary diarylamine (C1) and from 0 to 80 mol % of a hindered phenol (C2).

2) The use for adhesive bonding and sealing in the fields of building construction, the motor vehicle, railroad or aerospace industries, and shipbuilding.

One subject of the present invention is a sealant composition particularly suitable for obtaining assemblies capable of being exposed, over a long period, to extreme temperature and humidity climatic conditions and/or contact with water, with a view in particular to application in the field of construction and the manufacture of vehicles such as trains, subway trains or buses. The invention also relates to the use of said composition, and also to a process for the implementation thereof.

Sealants are widely used in many technical fields in order to assemble (or else to join or attach) two substrates which can be chosen from the most diverse materials. These sealants provide the assembly thus obtained with advantageous mechanical properties of solidity, elasticity and/or flexibility and also fluid tightness.

Among the technical fields in which sealants are used, mention may in particular be made of the construction of buildings, the motor vehicle, railroad or aerospace industry, and the field of shipbuilding, such as the construction of pleasure boats.

The mechanical properties of the assembly are determined by the cohesion of the adhesive joint, which is an intrinsic property of the latter, and also by the adhesion of said joint to the surface of each of the two substrates, which is dependent on the properties of the corresponding interface.

With regard to the construction of pleasure boats for example, sealants are commonly used due to their excellent sealing against water and moisture, for the assembly of the hull and of the deck, for the construction of internal bulkheads with a view to fitting out the onboard living spaces, and for furniture assembly. The substrates used are, in particular, often based on wood (varnished or untreated), resins such as a polyester, an epoxy, a polymethyl methacrylate (or PMMA) or a poly(acrylonitrile-butadiene-styrene) (or ABS), but can also be metallic (aluminum, stainless steel or galvanized or electrogalvanized steel).

External or environmental factors resulting from the conditions of use of the assembly are essential parameters to be considered for maintaining over time the advantageous mechanical properties of the sealant, in particular cohesion of the adhesive joint and the adhesion thereof to the surface of the two corresponding attached substrates.

For example, in the case of pleasure boats, it is essential for the adhesive joint to maintain its advantageous properties of cohesion and adhesion throughout the lifespan of the boat, when the joint is caused to deform under the effect of the vibrations produced by cruising, and under the combined action of prolonged contact with water and moisture, and climatic conditions, in particular high temperatures, which may range up to 40° C., and even up to 100° C.

The most common sealants on the market are generally in the form of compositions which comprise, in combination with a mineral filler, a moisture-crosslinkable prepolymer having a chemical structure provided with reactive isocyanate or alkoxysilane groups, these generally being end groups. At the time the sealant is used for producing the assembly, the reaction of these reactive groups with water which originates from the moisture in the air and/or from the substrates to be assembled, is referred to as a crosslinking reaction.

It is the completion of this reaction, after a period of time referred to as the crosslinking time, which enables the creation of a solid three-dimensional network which helps to confer the desired mechanical properties on the adhesive joint thus formed.

The sealant compositions based on prepolymers having alkoxysilane end groups (also referred to as silyl sealants) have the advantage of being free from isocyanates, particularly from monomeric diisocyanates. These compositions thus constitute an alternative, which is preferred from a toxicological viewpoint, to the compositions based on isocyanate-terminated polyurethanes.

The crosslinking reaction of these silyl sealants takes place, in the presence of moisture, by hydrolysis of the alkoxysilane groups borne by the prepolymer, followed by their condensation to form a siloxane bond (—Si—O—Si—) which unites the prepolymer chains to form a polymer forming a solid three-dimensional network.

International application WO2017/052373 describes a sealant comprising a silyl-terminated polymer, a filler and an antioxidant, the chemical formula of which comprises a phenol substituted by 2 alkyl radicals in the ortho position relative to the —OH group, said phenol also being substituted in the para position by a specific 6-membered ring chosen from a phenyl, a triazine and an isocyanurate. This international application mentions, for the corresponding crosslinked sealant, improved properties when it is exposed, for a prolonged period of time, to temperatures higher than ambient temperature and/or to high levels of radiation.

However, there is still a need to improve sealants, in particular with regard to the mechanical properties of the adhesive joint obtained after crosslinking, when the latter is placed, over a long period of time, under conditions which combine both high humidity, or even contact with water, with a very high temperature. Such a need is particularly marked, for example, in the field of the construction of pleasure boats, for obvious reasons, or even in the field of railroad construction for the external joints located on the roof of trains.

An objective of the present invention is to meet the need defined above, in part or completely.

The present invention thus relates to a sealant composition comprising, based on its total weight:
from 20% to 45% by weight of a silyl polymer (A);
from 30% to 55% by weight of a filler (B); and
from 0.05% to 5% by weight of an antioxidant composition (C) consisting, on the basis of the total number of moles of the compounds present in the composition (C):
   of 20 to 100 mol % of a secondary diarylamine (C1) of formula (1), (1′) or (1″):

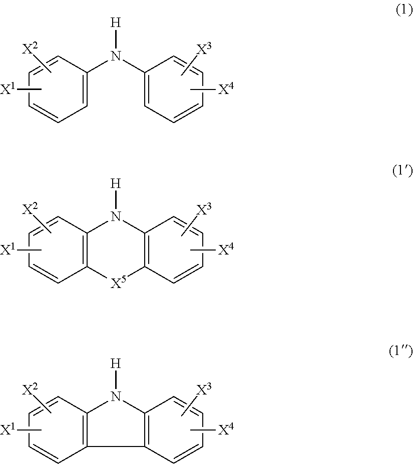

wherein:
   X¹, X², X³ and X⁴, which are identical or different, each represent a hydrogen atom or a radical having from 1 to 20 carbon atoms and chosen from alkyl, arylalkyl, aryl and alkylaryl; it being possible in addition for X¹ and X² or X³ and X⁴ to be respectively engaged in a ring;
   X⁵ represents an oxygen or sulfur atom, or a —C(R)(R′)— divalent radical wherein R and R′, which are identical or different, are a hydrogen atom or an alkyl radical having from 1 to 30 carbon atoms; and
from 0 to 80 mol % of a hindered phenol (C2) of formula (2):

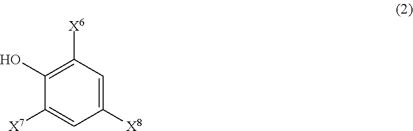

in which:
   X⁶ and X⁷, which are identical or different, represent a linear or branched alkyl radical comprising from 1 to 7 carbon atoms,
   X⁸ represents a linear, branched or cyclic alkyl radical comprising from 1 to 22 carbon atoms, with the optional presence of at least one heteroatom chosen from O or S or of a —COO— carbonyloxy function.

According to another aspect, the invention relates to a sealant composition comprising, on the basis of the total weight thereof:
from 20% to 45% by weight of a silyl polymer (A);
from 30% to 55% by weight of a filler (B); and
from 0.05% to 5% by weight of an antioxidant composition (C) consisting:
   of a secondary diarylamine (C1) of formula (1), (1′) or (1″), as defined above; and
   of a hindered phenol (C2) of formula (2) as defined above.

It has been found that the incorporation of the antioxidant compositions (C) in the sealant compositions according to the invention leads, surprisingly, after crosslinking of the sealant, to an adhesive joint of which both the mechanical properties (in particular of solidity) and the adhesion to various substrates, are maintained, and even often improved, when said joint is used over a long period of time and in an environment characterized by a high humidity, ranging up to 100% relative humidity, and by a high temperature, which may range up to 40° C., and even up to 100° C. These advantageous properties are further accentuated when the antioxidant composition (C) consists of a mixture of secondary diarylamine (C1) and hindered phenol (C2).

### Silyl polymer (A)

For the purposes of the present invention, a silyl polymer is understood to mean a polymer comprising at least one alkoxysilane group. Preferably, the silyl polymer (A) comprising at least one alkoxysilane group is a polymer comprising at least one, preferably at least two, groups of formula (I):

—Si(R⁴)ₚ(OR⁵)₃₋ₚ (I)

wherein:
R⁴ represents a linear or branched alkyl radical comprising from 1 to 4 carbon atoms, with the possibility that when there are several R⁴ radicals, these radicals are identical or different;
R⁵ represents a linear or branched alkyl radical comprising from 1 to 4 carbon atoms, with the possibility that when there are several R⁵ radicals, these radicals are identical or different, with the possibility that two OR⁵ groups may be engaged in the same ring; and
p is an integer equal to 0, 1 or 2, preferably equal to 0 or 1.

The silyl polymer as defined above comprises at least one crosslinkable alkoxysilane group. The crosslinkable alkoxysilane group is preferably in the terminal position of said polymer. However, a position in the middle of the chain is not excluded.

The silyl polymer (A) is generally in the form of a more or less viscous liquid. Preferably, the silyl polymer has a viscosity ranging from 10 to 200 Pa·s, preferably ranging from 20 to 175 Pa·s, said viscosity being measured, for example, according to a Brookfield method at 23° C. and 50% relative humidity (S28 spindle).

The silyl polymer (A) preferably comprises two groups of formula (I), but it may also comprise from three to six groups of formula (I).

Preferably, the silyl polymer(s) (A) have an average molar mass ranging from 500 to 50000 g/mol, more preferably ranging from 700 to 20000 g/mol. The molar mass of the polymers may be measured by methods well known to a person skilled in the art, for example by NMR and size exclusion chromatography using polystyrene standards.

According to one embodiment of the invention, the silyl polymer (A) corresponds to one of the formulae (II), (III) or (IV):

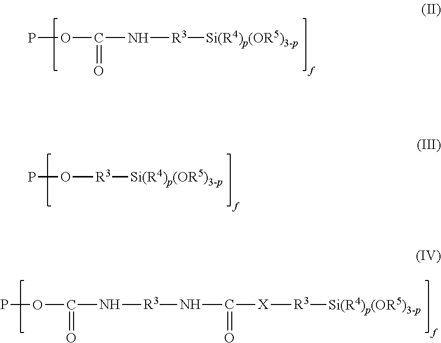

wherein:
   R⁴, R⁵ and p have the same meaning as in formula (I) described above,
   P represents a saturated or unsaturated, linear or branched polymeric radical optionally comprising one or more heteroatoms, such as oxygen, nitrogen, sulfur, silicon, and preferably having a number-average molar mass ranging from 100 g/mol to 48600 g/mol, more particularly from 300 g/mol to 18600 g/mol or from 500 g/mol to 12600 g/mol,
   R¹ represents a divalent hydrocarbon radical comprising from 5 to 15 carbon atoms which can be aromatic or aliphatic and linear, branched or cyclic,
   R³ represents a linear or branched divalent alkylene radical comprising from 1 to 6 carbon atoms, preferably from 1 to 3 carbon atoms,
   X represents a divalent radical chosen from —NH—, —NR⁷− or —S—,
   R⁷ represents a linear or branched alkyl radical comprising from 1 to 20 carbon atoms and which may also comprise one or more heteroatoms,
   f is an integer ranging from 1 to 6, preferably ranging from 2 to 5, preferably from 2 to 4, more preferably from 2 to 3.

Preferably, in formulae (II), (III) and/or (IV) above, P represents a polymer radical chosen, in a nonlimiting manner, from polyethers, polycarbonates, polyesters, polyolefins, polyacrylates, polyether polyurethanes, polyester polyurethanes, polyolefin polyurethanes, polyacrylate polyurethanes, polycarbonate polyurethanes, and block polyether/polyester polyurethanes.

For example, EP 2468783 describes silyl polymers of formula (II) in which P represents a polymer radical containing polyurethane/polyester/polyether blocks.

According to one embodiment, the silyl polymers are chosen from silyl polyurethanes, silyl polyethers, and mixtures thereof.

According to a particular embodiment, the silyl polymer corresponds to one of the formulae (II′), (III′) or (IV′):

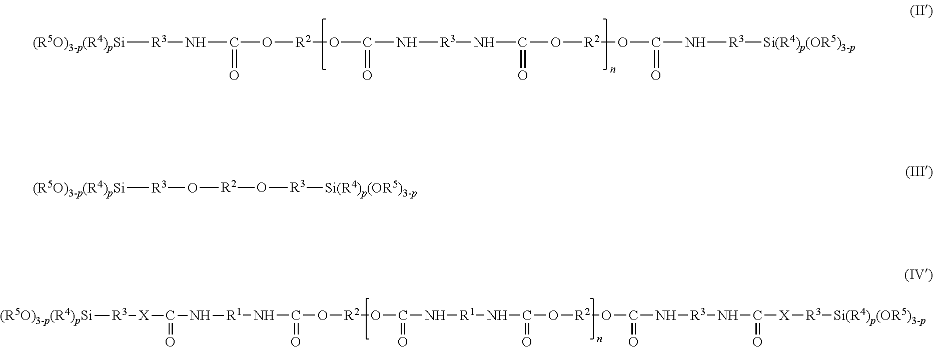

wherein:
R¹, R³, R⁴, R⁵, X, R⁷ and p have the same meaning as in formulae (II), (III) and (IV) described above,
R² represents a saturated or unsaturated, linear or branched divalent hydrocarbon radical optionally comprising one or more heteroatoms, such as oxygen, nitrogen, sulfur, silicon, and preferably having a number-average molar mass ranging from 100 g/mol to 48600 g/mol, more particularly from 300 g/mol to 18600 g/mol or else from 500 g/mol to 12600 g/mol, and
n is an integer greater than or equal to 0.

In the silyl polymers of formula (II′), (III′) or (IV′) defined above, when the R² radical comprises one or more heteroatoms, said heteroatom(s) are not present at the end of the chain. In other words, the free valencies of the divalent R² radical bonded to the neighboring oxygen atoms of the silyl polymer each originate from a carbon atom. Thus, the main chain of the R² radical is terminated with a carbon atom at each of the two ends, said carbon atom then having a free valency.

According to one embodiment, the silyl polymers (A) are obtained from polyols chosen from polyether polyols, polyester polyols, polycarbonate polyols, polyacrylate polyols, polysiloxane polyols and polyolefin polyols, and mixtures thereof, and more preferably from diols chosen from polyether diols, polyester diols, polycarbonate diols, polyacrylate diols, polysiloxane diols, polyolefin diols, and mixtures thereof. In the case of the polymers of formula (II′), (III′) or (IV′) described above, such diols may be represented by the formula HO—R²—OH where R² has the same meaning as in formula (II′), (III′) or (IV′).

For example, among the radicals of R² type which may be present in formula (II′), (III′) or (IV′), mention may be made of the following divalent radicals, of which the formulae below show the two free valencies:
derivative of a polypropylene glycol:

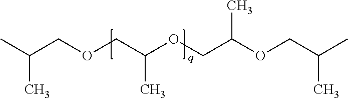

derivative of a polyester diol:

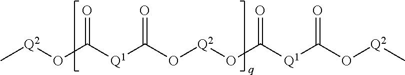

derivative of a polybutadiene diol:

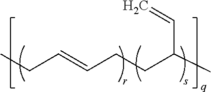

derivative of a polyacrylate diol:

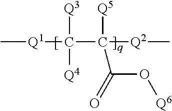

derivative of a polysiloxane diol:

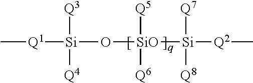

wherein:
q represents an integer such that the number-average molecular mass of the R² radical ranges from 100 g/mol to 48600 g/mol, preferably from 300 g/mol to 18600 g/mol, more preferably from 500 g/mol to 12600 g/mol,
r and s represent zero or a non-zero integer such that the number-average molecular mass of the R² radical ranges from 100 g/mol to 48600 g/mol, preferably from 300 g/mol to 18600 g/mol, more preferably from 500 g/mol to 12600 g/mol, it being understood that the sum r+s is other than zero,
Q¹ represents a linear or branched, saturated or unsaturated, aromatic or aliphatic divalent alkylene radical preferably containing from 1 to 18 carbon atoms, more preferably from 1 to 8 carbon atoms,
Q² represents a linear or branched divalent alkylene radical preferably containing from 2 to 36 carbon atoms, more preferably from 1 to 8 carbon atoms,
Q³, Q⁴, Q⁵, Q⁶, Q⁷ and Q⁸ represent, independently of each other, a hydrogen atom or an alkyl, alkenyl or aromatic radical preferably containing from 1 to 12 carbon atoms, preferably from 2 to 12 carbon atoms, more preferably from 2 to 8 carbon atoms.

According to one embodiment, R¹ is chosen from one of the following divalent radicals, of which the formulae below show the two free valencies:
a) the divalent radical derived from isophorone diisocyanate (IPDI):

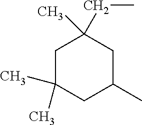

b) the divalent radical derived from dicyclohexylmethane diisocyanate (H12MDI)

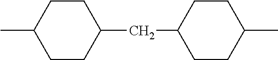

c) the divalent radical derived from toluene diisocyanate (TDI)

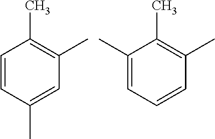

d) the divalent radicals derived from the 4,4′ and 2,4′ isomers of diphenylmethane diisocyanate (MDI)

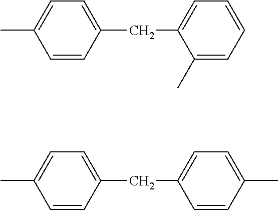

e) the divalent radical derived from hexamethylene diisocyanate (HDI) —(CH₂)₆—
f) the divalent radical derived from m-xylylene diisocyanate (m-XDI).

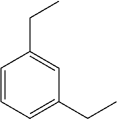

The polymers of formula (II) or (II′) may be obtained according to a process described in documents EP 2336208 and WO 2009/106699. A person skilled in the art will know how to adapt the manufacturing process described in these two documents in the case of the use of different types of polyols. Among the polymers corresponding to formula (II), mention may be made of:
Geniosil® STP-E10 (available from Wacker-Chemie): polyether comprising two groups (I) of dimethoxy type (n equal to 0, p equal to 1 and R⁴ and R⁵ represent a methyl group) having a number-average molar mass of 8889 g/mol where R³ represents a methyl group;
Geniosil® STP-E30 (available from Wacker-Chemie): polyether comprising two groups (I) of dimethoxy type (n equal to 0, p equal to 1 and R⁴ and R⁵ represent a methyl group) having a number-average molar mass of 14493 g/mol where R³ represents a methyl group;
Spur+® 1050MM (available from Momentive): polyurethane comprising two groups (I) of trimethoxy type (n other than 0, p equal to 0 and R⁵ represents a methyl group) having a number-average molar mass of 16393 g/mol where R³ represents an n-propyl group;
Spur+® Y-19116 (available from Momentive): polyurethane comprising two groups (I) of trimethoxy type (n other than 0 and R⁵ represents a methyl group) having a number-average molar mass ranging from 15000 to 17000 g/mol where R³ represents an n-propyl group;
Desmoseal® S XP 2636 (available from Bayer): polyurethane comprising two groups (I) of trimethoxy type (n other than 0, p equal to 0 and R⁵ represents a methyl group) having a number-average molar mass of 15038 g/mol where R³ represents an n-propylene group.

The polymers of formula (III) or (III′) may be obtained by hydrosilylation of polyether diallyl ether according to a process described, for example, in document EP 1 829 928. Among the polymers corresponding to formula (III), mention may be made of:
the polymer MS SAX® 350 (available from Kaneka) corresponding to a polyether comprising two groups (I) of dimethoxy type (p equal to 1 and R⁴ and R⁵ represent a methyl group) having a number-average molar mass ranging from 14000 to 16000 g/mol;
the polymer MS SAX® 260 (available from Kaneka) corresponding to a polyether comprising two groups (I) of dimethoxy type (p equal to 1 and R⁴ and R⁵ represent a methyl group) having a number-average molar mass of 16000 to 18000 g/mol where R³ represents an ethyl group;
the polymer MS S303H (available from Kaneka) corresponding to a polyether comprising two groups (I) of dimethoxy type (p is equal to 1 and R⁴ represents a methyl group) having a number-average molecular mass of about 22 000 daltons.

The polymers of formula (IV) or (IV′) may be obtained, for example, by reaction of polyol(s) with one or more diisocyanates followed by a reaction with aminosilanes or mercaptosilanes. A process for preparing polymers of formula (IV) or (IV′) is described in document EP 2 583 988. A person skilled in the art will know how to adapt the manufacturing process described in said document in the case of using different types of polyols.

According to a preferred embodiment of the invention, the silyl polymer (A) is a polymer of formula (IV′) (often referred to by the term SPUR), and even more preferably a polymer of formula (IV′) in which :
R¹ is the divalent radical derived from isophorone diisocyanate (IPDI)
R² is derived from a polypropylene glycol
X is the —NR⁷ radical.

According to an even more preferred embodiment, the silyl polymer (A) is a polymer of formula (IV′) in which:
R¹ is the divalent radical derived from isophorone diisocyanate (IPDI),
R² is derived from a polypropylene glycol,
R³ is the radical: —(CH₂)₃—,
X is the —N(nBu)- radical,
R⁵ is the methyl radical, and
p=0.

According to another preferred variant, the composition of the sealant according to the invention comprises from 25% to 40% by weight of the silyl polymer (A).

### Filler (B)

The sealant composition according to the invention comprises from 30% to 55% by weight of one (or more) filler(s) (B).

The filler(s) which can be used in the sealant composition according to the invention can be chosen from mineral fillers, organic fillers and mixtures of organic fillers and mineral fillers.

As examples of mineral filler(s) that can be used, use may be made of any mineral filler(s) usually used in the field of sealant compositions. These fillers are in the form of particles of varied geometry. They can, for example, be spherical or fibrous or exhibit an irregular shape.

Preferably, use is made of clay, quartz or carbonate fillers.

More preferably, use is made of carbonate fillers, such as alkali metal or alkaline earth metal carbonates, and more preferably calcium carbonate or chalk.

These fillers may be untreated or treated, for example using an organic acid, such as stearic acid, or a mixture of organic acids predominantly consisting of stearic acid.

Use may also be made of hollow mineral microspheres, such as hollow glass microspheres, and more particularly of those made of calcium sodium borosilicate or of aluminosilicate.

As examples of organic filler(s) which can be used, use may be made of any organic filler(s) and in particular polymeric filler(s) customarily used in the field of sealant compositions.

Use may be made, for example, of polyvinyl chloride (PVC), polyolefins, rubber, ethylene vinyl acetate (EVA), or aramid fibres such as Kevlar®.

Use may also be made of expandable or non-expandable hollow microspheres made of thermoplastic polymer. Mention may in particular be made of hollow microspheres made of vinylidene chloride/acrylonitrile.

Preferably, use is made of PVC.

The mean particle size of the filler(s) which can be used is preferably less than or equal to 10 microns, more preferentially less than or equal to 3 microns, in order to prevent them from settling in the adhesive sealant composition according to the invention during its storage.

The mean particle size is measured for a volume particle size distribution corresponding to 50% by volume of the sample of particles analyzed. When the particles are spherical, the mean particle size corresponds to the median diameter (D50 or Dv50), which corresponds to the diameter such that 50% of the particles by volume have a size which is smaller than said diameter. In the present patent application, this value is expressed in micrometers and determined according to the standard NF ISO 13320-1 (1999) by laser diffraction on an appliance of Malvern type.

According to a preferred variant, the composition of the sealant according to the invention comprises from 35% to 50% by weight of filler (B).

### Antioxidant Composition (C)

The antioxidant composition (C) which is included in the sealant composition according to the invention consists, on the basis of the total number of moles of the compounds present in the composition (C):
of 20 to 100 mol % of a secondary diarylamine (C1) of formula (1), (1′) or (1″):

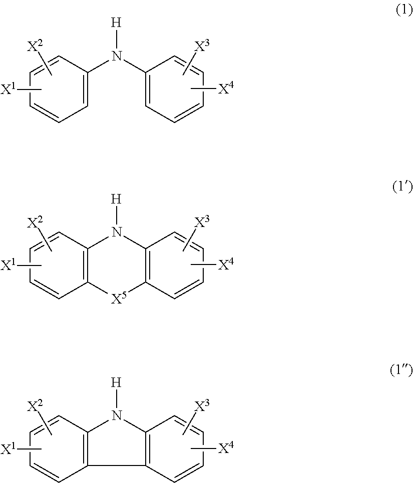

wherein:
   X¹, X², X³ and X⁴, which are identical or different, each represent a hydrogen atom or a radical having from 1 to 20 carbon atoms and chosen from alkyl, arylalkyl, aryl and alkylaryl; it being possible in addition for X¹ and X² or X³ and X⁴ to be respectively engaged in a ring;
   X⁵ represents an oxygen or sulfur atom, or a —C(R)(R′)— divalent radical wherein R and R′, which are identical or different, are a hydrogen atom or an alkyl radical having from 1 to 30 carbon atoms; and
from 0 to 80 mol % of a hindered phenol (C2) of formula (2):

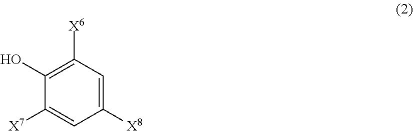

in which:
   X⁶ and X⁷, which are identical or different, represent a linear or branched alkyl radical comprising from 1 to 7 carbon atoms,
   X⁸ represents a linear, branched or cyclic alkyl radical comprising from 1 to 22 carbon atoms, with the optional presence of at least one heteroatom chosen from O or S or of a —COO— carbonyloxy function.

Alternatively, the antioxidant composition (C) which is included in the sealant composition according to the invention consists:
of a secondary diarylamine (C1) of formula (1), (1′) or (1″):

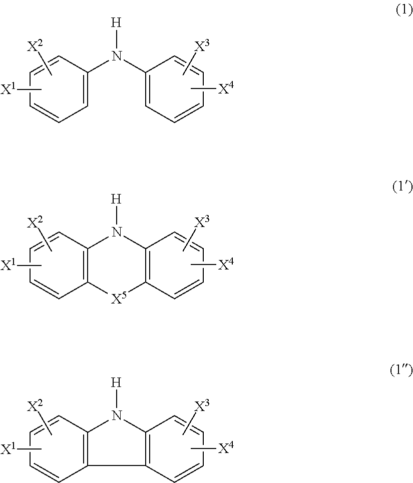

wherein:
   X¹, X², X³ and X⁴, which are identical or different, each represent a hydrogen atom or a radical having from 1 to 20 carbon atoms and chosen from alkyl, arylalkyl, aryl and alkylaryl; it being possible in addition for X¹ and X² or X³ and X⁴ to be respectively engaged in a ring;
   X⁵ represents an oxygen or sulfur atom, or a —C(R)(R′)— divalent radical wherein R and R′, which are identical or different, are a hydrogen atom or an alkyl radical having from 1 to 30 carbon atoms; and
of a hindered phenol (C2) of formula (2):

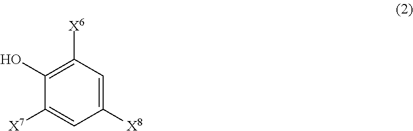

in which:
   X⁶ and X⁷, which are identical or different, represent a linear or branched alkyl radical comprising from 1 to 7 carbon atoms,
   X⁸ represents a linear, branched or cyclic alkyl radical comprising from 1 to 22 carbon atoms, with the optional presence of at least one heteroatom chosen from O or S or of a —COO— carbonyloxy function.

The following embodiments of the secondary diarylamine (C1) of formula (1), (1′) or (1″) are preferred:
X¹, X², X³ and X⁴, which are identical or different, each represent a hydrogen atom or a radical having from 1 to 10 carbon atoms and chosen from alkyl, arylalkyl, aryl and alkylaryl;
X² and X⁴ each represent a hydrogen atom and X¹ and X³ each represent an alkyl radical having 3 to 7 carbon atoms, substituted by a phenyl group, said alkyl radical being more preferentially branched;
X² and X⁴ each represent a hydrogen atom and X¹ and X³ each represent an alkyl radical having 3 to 7 carbon atoms, more preferentially which is branched, positioned in the para position relative to the nitrogen atom, said alkyl radical being substituted by a phenyl group;

According to a very particularly preferred embodiment, the secondary diarylamine (C1) is of formula (1).

The secondary diarylamine (C1) of formula (1) includes antioxidants that are commonly commercially available, among which mention may be made of:
the compound corresponding to the formula below:

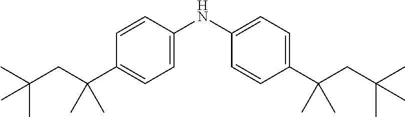 [SMILES: CC(C)(C)CC(C)(C)c1ccc(Nc2ccc(C(C)(C)CC(C)(C)C)cc2)cc1]

which is available from BASF under the name IRGANOX® 5057;
the compound named 4,4′-bis(1,1-dimethylbenzyl)diphenylamine (CAS number: 10081-67-1) which corresponds to the formula below:

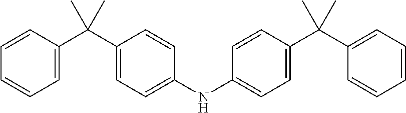 [SMILES: CC(C)(c1ccccc1)c1ccc(Nc2ccc(C(C)(C)c3ccccc3)cc2)cc1]

and which is available from OKA-TEC under the trade name OKABEST® AO 445 or else from ADDIVANT under the trade name NAUGARD® 445.

According to a preferred embodiment, the hindered phenol (C2) of formula (2) is such that:
X⁶ and X⁷ represent a branched alkyl radical comprising from 3 to 4 carbon atoms, and
X⁸ represents an alkyl radical comprising from 10 to 22 carbon atoms, even more preferentially from 16 to 22 carbon atoms, and comprising a carbonyloxy group.

The hindered phenol (C2) of formula (2) includes antioxidants that are commonly commercially available, among which mention may be made of:
the compound named octadecyl ester of 3,5-di-tert-butyl-4-hydroxyphenylpropionic acid (CAS number: 2082-79-3), corresponding to the formula below:

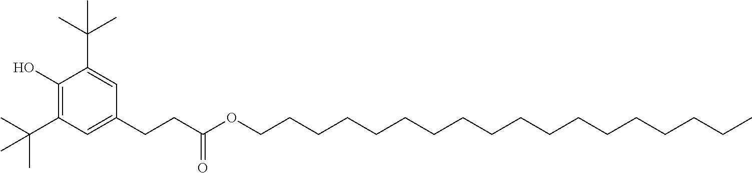 [SMILES: CCCCCCCCCCCCCCCCCCOC(=O)CCc1cc(C(C)(C)C)c(O)c(C(C)(C)C)c1]

which is available from BASF under the name IRGANOX® 1076.

According to a 1st embodiment, the antioxidant composition (C) consists of 100 mol % of the secondary diarylamine (C1) of formula (1), (1′) or (1″).

According to a 2nd embodiment, the antioxidant composition (C) consists, on the basis of the total number of moles of (C1) and (C2), of from 20 to 80 mol % of (C1) and of from 20 to 80 mol % of (C2), preferably from 20% to 60% of (C1) and from 40% to 80% of (C2), even more preferably from 20% to 40% of (C1) and from 60% to 80% of (C2), and finally advantageously from 20% to 30% of (C1) and from 70% to 80% of (C2).

Composition (C) as defined above is included in the sealant composition according to the invention, in a proportion of from 0.05% to 5% by weight, on the basis of the total weight of said composition, and preferably in a proportion of from 0.05% to 1%, and very especially from 0.1% to 0.5% by weight.

### Crosslinking Catalyst (D)

The sealant composition according to the invention can comprise, and preferably comprises, from 0.01% to 1% of a crosslinking catalyst (D), on the basis of the total weight of said composition.

The catalyst (D) can be any catalyst known to those skilled in the art for the condensation of silanol. Mention may be made, as examples of such catalysts, of:
organotitanium derivatives, such as titanium acetylacetonate (commercially available under the name Tyzor® AA75 from DuPont de Nemours);
aluminum, such as aluminum chelate (commercially available under the name K-KAT® 5218 from King Industries);
amines, such as 1,8-diazabicyclo[5.4.0]undec-7-ene (DBU) or 1,5-diazabicyclo[4.3.0]non-5-ene (DBN), 2,2′-dimorpholinodiethyl ether (DMDEE) or 1,4-diazabicylo[2.2.2]octane (DABCO);
tin-based catalysts, such as, for example, Neostann® S-1 or TIB-KAT® 216 (respectively available from Kaneka or TIB Chemicals), or else DBTL (dibutyl tin laurate), widely commercially available;
catalysts based on zinc carboxylate and DBU (commercially available under the name K-KAT® 670 from King Industries).

The catalyst(s) (D) preferably represent from 0.02% to 0.5% by weight, relative to the total weight of the composition.

### Other Additives

According to one embodiment, the sealant composition according to the invention comprises, in addition to the ingredients (A), (B) and (C), from 0% to 30% by weight, in particular from 0.5% to 30% by weight, preferably from 10% to 27% by weight, of at least one additive chosen from plasticizers, adhesion promoters, moisture absorbers, rheological agents, solvents, pigments and UV stabilizers.

The composition according to the invention can in particular comprise at least one plasticizing agent in a proportion of 5% to 30% by weight, preferably of 5% to 20% by weight, relative to the total weight of said composition.

Use may be made, by way of example of plasticizing agent which can be used, of any plasticizing agent generally used in the field of sealant compositions.

Preferably, use is made of:
diisodecyl phthalate (or DIDP), as sold under the name Palatinol™ DIDP by BASF, or else diisononyl phthalate (DINP), sold by BASF under the name Palatinol® N.
an alkylsulfonic acid ester of phenol, as sold under the name Mesamoll® by Lanxess,
diisononyl 1,2-cyclohexanedicarboxylate, as sold under the name Hexamoll Dinch® by BASF,
pentaerythritol tetravalerate, as sold under the name Pevalen™ by Perstorp.

The composition according to the invention may also comprise up to 3% by weight of an adhesion promoter which can be for example an aminosilane, such as 3-aminopropyltrimethoxysilane (also known as AMMO) or n-butyl-3-aminopropyltrimethoxysilane (commercially available under the name Dynasilan® 1189).

The composition according to the invention may also comprise up to 3% by weight of a moisture absorber which can be chosen from vinyltrimethoxysilane (VTMO), vinyltriethoxysilane (VTEO) or alkoxyarylsilanes, such as Geniosil® XL 70 available from Wacker.

The composition according to the invention may also comprise from 1% to 30% by weight (relative to the total weight of the composition according to the invention) of a rheological agent, preferably from 5% to 20% by weight.

Mention may be made, by way of example of a rheological agent, of any rheological agent normally used in the field of sealant compositions.

Preferably, use is made of one or more rheological agents chosen from thixotropic agents, and more preferentially from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica,
urea derivatives resulting from the reaction of an aromatic diisocyanate monomer, such as 4,4′-MDI, with an aliphatic amine, such as butylamine. The preparation of such urea derivatives is described notably in application FR1 591 172;
micronized amide waxes, such as CRAYVALLAC SLX sold by Arkema, or else THIXATROL® MAX which is available from ELEMENTIS (EC Number: 432-430-3) and which consists of N,N′-ethane-1,2-diylbis(hexanamide), 12-hydroxy-N-[2-[(1-oxyhexyl)amino]ethyl]octadecanamide and N,N′-ethane-1,2-diylbis(12-hydroxyoctadecanamide).

The composition according to the invention may also comprise from 0% to 5% by weight of a solvent, preferably a solvent that is volatile at ambient temperature (temperature of about 23° C.). The volatile solvent may, for example, be chosen from alcohols which are volatile at ambient temperature, such as ethanol or isopropanol. The volatile solvent makes it possible, for example, to reduce the viscosity of the composition and make the composition easier to apply. The volatile character of the solvent makes it possible for the seal, obtained after curing the composition, to no longer contain solvent. Thus, the solvent has, for example, no negative influence on the mechanical properties of the joint.

The composition according to the invention may also comprise up to 3% by weight of a pigment chosen from organic or inorganic pigments. For example, the pigment may be TiO₂, in particular Kronos® 2059 sold by Kronos.

The composition according to the invention may also comprise UV stabilizers, among which mention may be made of benzotriazoles, benzophenones, and mixtures thereof. Mention may be made, for example, of the products Tinuvin® 328, Tinuvin™ 770 or else Tinuvin™ 765, sold by BASF. Tinuvin™ 765 is a UV stabilizer composition consisting of bis(1,2,2,6,6-pentamethyl-4-piperidyl) sebacate and 1-(methyl)-8-(1,2,2,6,6-pentamethyl-4-piperidyl) sebacate (CAS numbers: 41556-26-7 and 82919-37-7).

According to a preferred variant, the sealant composition according to the invention comprises:
25% to 40% by weight of the silyl polymer (A);
35% to 50% by weight of filler (B); and
0.1% to 0.5% by weight of the antioxidant composition (C).

According to a more preferred variant, the sealant composition according to the invention comprises, and preferably essentially consists of:
25% to 40% by weight of the silyl polymer (A);
35% to 50% by weight of filler (B);
0.1% to 0.5% by weight of the antioxidant composition (C);
0.02% to 0.5% by weight of catalyst (D);
5% to 20% by weight of a plasticizing agent;
0.5% to 2% of an adhesion promoter;
1% to 2% by weight of a moisture absorber;
5% to 10% by weight of a rheological agent;
1% to 3% of a solvent;
1% to 3% of a pigment; and
0.05% to 0.5% of a UV stabilizer.

The composition which is the subject of the invention can be prepared by simply mixing its ingredients. For example, the silyl polymer (A) can be mixed, in a suitable container, with liquid additives such as a plasticizer, a solvent, a moisture absorber and a UV stabilizer composition. Then, solid additives, such as a filler, a rheological agent and a pigment are dispersed in the preceding liquid mixture, for the time required. Finally, other liquid ingredients, such as an adhesion promoter and the catalyst, are added last.

Another subject of the present invention is the use of the sealant composition, as defined above, for adhesive bonding and sealing in the fields of building construction, the motor vehicle, railroad or aerospace industries, and shipbuilding, preferably for the construction of pleasure boats.

A final subject of the present invention is a process for assembling two substrates by adhesive bonding, comprising:
the coating, onto at least one of the two substrates to be assembled, of the sealant composition as defined previously; then
effectively bringing the two substrates into contact.

Suitable substrates are, for example, chosen from inorganic substrates such as concrete, metals or alloys (such as aluminum alloys, steel, non-ferrous metals and galvanized metals); or else from organic substrates such as wood (varnished or untreated), resins such as a polyester, an epoxy, a polymethyl methacrylate (or PMMA) or a poly(acrylonitrile-butadiene-styrene) (or ABS).

The invention is now described in the following exemplary embodiments, which are given purely by way of illustration and should not be interpreted in order to limit the scope thereof.

### EXAMPLES

The following ingredients were used:
Polymer A₀: silyl polymer, of SPUR type, prepared in accordance with example A below.
CATALEM® C 16 T: filler consisting of (natural) calcium carbonate available from LA PROVENCALE.
OKABEST® CLX-50: antioxidant composition consisting of 22 mol % of OKABEST® AO 445 (available from OKA-TEC) and 78 mol % of Irganox® 1076 (available from BASF).
OKABEST® AO 445: antioxidant available from OKA-TEC.
DYNASYLAN® AMMO: adhesion promoter available from EVONIK.
DYNASYLAN® VTMO: moisture absorber consisting of vinyltrimethoxysilane, available from EVONIK.
THIXATROL® MAX: rheological agent which consists of N,N′-ethane-1,2-diylbis(hexanamide), 12-hydroxy-N-[2-[(1-oxyhexyl)amino]ethyl]octadecanamide and N,N′-ethane-1,2-diylbis(12-hydroxyoctadecanamide), and which is available from Elementis.
Titanium dioxide (CAS number: 13463-67-7): white pigment available from KRONOS INTERNATIONAL
TINUVIN™ 765: UV stabilizer composition consisting of bis(1,2,2,6,6-pentamethyl-4-piperidyl) sebacate and 1-(methyl)-8-(1,2,2,6,6-pentamethyl-4-piperidyl) sebacate, which is available from BASF.

### Example A (Reference): Preparation of the Silyl Polymer (A₀)

The polymer (A₀) is prepared according to the following 2-step procedure.

Introduced into a reactor are Acclaim® 12200 (polyether polyol having an HV of 9 to 11 mg KOH/g, and a number-average molecular mass of around 12000, sold by COVESTRO) followed by a dehydrating agent Ti (para-toluenesulfonyl isocyanate sold by BORCHER) and the medium is heated at 60-65° C. Next, the IPDI is introduced, the mixture is mixed for 10 min and then the catalyst K-KAT XK-664 (zinc carboxylate sold by King Industry) is introduced. The mixture is then heated to 70° C. for one hour with stirring. The NCO index is then checked; if the theoretical NCO index is not reached, the reaction time is extended by as many periods of 15 minutes as necessary.

When the theoretical NCO index is reached, the Dynasilan 1189 (n-butyl-3-aminopropyltrimethoxysilane from Evonik) is added, and the mixture is stirred for 10 minutes. The reactor is then placed in cooling mode and the VTMO and also the DINP (diisononyl phthalate) are added; the mixture is then kept under stirring for 20 minutes.

A product consisting essentially of 85.53% by weight/weight of SPUR silyl polymer (A₀) and of 13.90% by weight/weight of DINP plasticizer.

### Example 1 (According to the Invention)

The sealant composition listed in table 1 below was prepared by mixing the ingredients according to the procedure indicated above. The content of ingredient is indicated as % weight/weight.

After it has been prepared, the composition is stored in a sealed cartridge, and then it is subjected to the following tests.

TABLE 1

| | | Content (as % weight/weight) | | |
|---|---|---|---|---|
| | | | Ex. B | Ex. C |
| | Ingredients | Ex. 1 | (comparative) | (comparative) |
| (A) | Polymer A₀ | 28.43 | 28.43 | 28.52 |
| (B) | CATALEM ® C 16 T | 42.94 | 42.94 | 42.94 |
| (C) | OKABEST ® CLX-50 | 0.137 | — | — |
| (C) | OKABEST ® AO 445 | — | — | 0.04 |
| (D) | DBTL | 0.05 | 0.10 | 0.05 <to be |
| | | | | confirmed> |
| | Diisononyl phthalate | 15.29 | 15.37 | 15.30 <to be |
| | (DINP) | | | confirmed> |
| | DYNASYLAN ® | 0.96 | 0.96 | 0.96 |
| | AMMO | | | |
| | DYNASYLAN ® | 1.95 | 1.95 | 1.95 |
| | VTMO | | | |
| | THIXATROL ® MAX | 5.75 | 5.75 | 5.75 |
| | Ethanol | 2.00 | 2.00 | 2.00 |
| | Titanium dioxide | 2.39 | 2.39 | 2.39 |
| | TINUVIN ™ 765 | 0.10 | 0.10 | 0.10 |

### 1. Measurement of the Shear Strength of an Assembly Consisting of 2 Substrates Joined by the Crosslinked Sealant

### 1.1. Preparing a Specimen Assembly

Use is made of 2 rectangular plates of the same substrate with dimensions of: 100 mm×25 mm×2 mm After cleaning the 2 plates with isopropanol, a rectangular adhesive bonding area with dimensions of 12.5 mm×25 mm is defined, using adhesive tape, at the end of each plate.

On the adhesive bonding area of a 1^{st} substrate plate thus created, the sealant composition prepared above is applied, in an amount corresponding to a thickness of 2 mm Next, superimposed on the area thus coated is the adhesive bonding area of the 2^{nd} substrate plate, so as to obtain an assembly in which the free ends of the 2 substrate plates are aligned on either side of the 2 areas joined by the sealant.

The specimen assembly obtained is held by clips for 14 days in a room with a controlled atmosphere at 23° C. and 50% relative humidity, for crosslinking of the sealant.

### 1.2. Measurement of the Shear Strength Immediately After Crosslinking

For each of the substrates tested, 3 specimen assemblies are prepared in accordance with point 1.1.

The 2 free ends of each specimen are pulled by means of a tensile testing machine at a constant speed equal to 50 mm/minute, until the assembly breaks, for which the applied stress is recorded.

The average of the shear stresses at break obtained for the 3 specimen assemblies, expressed in MPa, is referred to as “Initial stress at break σ₀” and is noted in table 2, for each of the substrates indicated.

### 1.3. Measurement of the Shear Strength After a Period in Boiling Water

For each of the substrates tested, 3 specimen assemblies are prepared in accordance with point 1.1.

Said specimens are then immersed in boiling water for 6 hours, then the stress at break is measured as indicated in point 1.2.

The average of the shear stresses at break obtained for the 3 specimen assemblies, expressed in MPa, is referred to as “Stress at break after boiling water σ₁” and is noted in table 2, for each of the substrates indicated.

The variation in the stress at break after a period in boiling water, relative to the initial stress at break, before said period in boiling water, is calculated by the formula:

(σ₁−σ₀)/σ₀

and is indicated in % in table 2.

### 1.4. Measurement of Shear Strength After a Temperature/Humidity Cycle

For each of the substrates tested, 3 specimen assemblies are prepared in accordance with point 1.1.

Said specimens are then subjected to an alternating cycle of 1 hour at 80° C. and 90% relative humidity and 1 hour at −20° C., said cycle being repeated 24 times. The stress at break is then measured as indicated in point 1.2.

The average of the shear stresses at break obtained for the 3 assembly specimens, expressed in MPa, is referred to as “stress at break after temperature/humidity cycle σ₂” and is noted in table 2, for each of the substrates indicated.

The variation in the stress at break thus measured after said cycle, relative to the initial stress at break before said cycle, is calculated by the formula:

(σ₂−σ₀)/σ₀

and is indicated in % in table 2.

For each of the substrates tested, it is observed, for the sealant composition of example 1, that the tests involving storage of the assemblies have the effect of increasing the shear stress at break.

Such an increase is indicative of a very significant improvement in the solidity of the corresponding adhesive joint.

TABLE 2
Shear strength

| | | | Ex. B | Ex. C |
|---|---|---|---|---|
| | Substrate | Ex. 1 | (comparative) | (comparative) |
| Initial stress at | Aluminum | 0.95 | 1.63 | 1.31 |
| break σ₀ | Stainless | 1.04 | 1.45 | 1.31 |
| (in MPa) | steel | | | |
| | Polyester | 1.00 | 1.31 | 1.30 |
| Stress at break | Aluminum | 1.01 | 1.49 | 1.16 |
| after boiling | Stainless | 1.09 | 1.36 | 1.01 |
| water σ₁ | steel | | | |
| (in MPa) | Polyester | 1.10 | 1.20 | 1.11 |
| Variation (σ₁ − | Aluminum | +6 | −9 | −11 |
| σ₀)/σ₀ | Stainless | +5 | −6 | −23 |
| (in %) | steel | | | |
| | Polyester | +10 | −8 | −15 |
| Stress at break | Aluminum | 1.51 | 1.35 | 1.15 |
| after temperature/ | Stainless | 1.35 | 1.37 | 1.16 |
| humidity cycle σ₂ | steel | | | |
| (in MPa) | Polyester | 1.47 | 1.32 | 1.14 |
| Variation (σ₂ − | Aluminum | +59 | −17 | −12 |
| σ₀)/σ₀ | Stainless | +30 | −6 | −11 |
| (in %) | steel | | | |
| | Polyester | +47 | +1 | −12 |

### 2. Measurement of the Tensile Strength of a Test Specimen Made of the Crosslinked Sealant

### 2.1. Preparation of the Test Specimen

Use is made of a standard test specimen in the shape of a type 1 dumbbell, as illustrated in the international standard ISO 37. The narrow part of the dumbbell used has a length of 33 mm, a width of 6 mm and a thickness of 2 mm

To prepare the dumbbell, the sealant composition to be tested is placed in a Teflon mold, and the composition is left to crosslink for 14 days under the standard conditions (23° C. and 50% relative humidity).

### 2.2. Measurement of the Tensile Strength Immediately After Crosslinking

5 test specimens are prepared in accordance with point 2.1.

The principle of the measurement consists in stretching a standard test specimen in a tensile testing machine, the movable jaw of which is moved at a constant speed equal to 500 mm/minute, and in recording:
the elongation of the test specimen (expressed in %) during the stretching thereof,
the tensile stress (in MPa) corresponding to an elongation of 100% of the test specimen (referred to as “modulus at 100%”), and
the tensile stress (in MPa) at which rupture of the test specimen occurs.

The measurement is repeated for each of the 5 test specimens prepared, and the corresponding average of the results obtained for the modulus at 100% and the tensile stress at break (expressed in MPa) is indicated in table 3 below under the respective headings: “Initial modulus at 100% μ₀” and “Initial stress at break τ₀”.

### 2.3. Measurement of the Tensile Strength After a Period in Boiling Water

5 test specimens are prepared in accordance with point 2.1.

Said test specimens are then immersed in boiling water for 6 hours, then the modulus at 100% and stress at break are measured as indicated in point 2.2.

The corresponding average of the results obtained is indicated in table 3 below under the respective headings: “Modulus at 100% after boiling water μ₁” and “Stress at break after boiling water τ₁”.

The variations of these values, compared to the initial values measured immediately after crosslinking, are calculated by the formulae:

(μ₁−μ₀)/μ₀(τ₁−τ₀)/τ₀

and are indicated in % in table 3.

### 2.4. Measurement of the Tensile Strength After a Temperature/Humidity Cycle

5 test specimens are prepared in accordance with point 2.1.

Said test specimens are then subjected to an alternating cycle of 1 hour at 80° C. and 90% relative humidity and 1 hour at −20° C., said cycle being repeated 24 times. The modulus at 100% and the stress at break are then measured as indicated in point 2.2.

The corresponding average of the results obtained is indicated in table 3 below under the respective headings: “Modulus at 100% after temperature/humidity cycle μ₂” and “Stress at break after temperature/humidity cycle τ₂”.

The variations of these values, compared to the initial values measured immediately after crosslinking, are calculated by the formulae:

(μ₂−μ₀)/μ₀(τ₂−τ₀)/τ₀

and are indicated in % in table 3.

TABLE 3
Tensile strength

| | | Ex. B | Ex. C |
|---|---|---|---|
| | Ex. 1 | (comparative) | (comparative) |
| Initial modulus at 100% μ₀ | 1.29 | 1.89 | 1.38 |
| (in MPa) | | | |
| Initial stress at break τ₀ | 1.71 | 2.19 | 1.82 |
| (in MPa) | | | |
| Modulus at 100% after | 1.23 | 1.56 | 1.13 |
| boiling water μ₁ | | | |
| (in MPa) | | | |
| Variation (μ₁ − μ₀)/μ₀ | −5 | −17 | −18 |
| (in %) | | | |
| Stress at break after boiling | 1.93 | 2.13 | 1.89 |
| water τ₁ | | | |
| (in MPa) | | | |
| Variation (τ₁ − τ₀)/τ₀ | +13 | −3 | +4 |
| (in %) | | | |
| Modulus at 100% after | 1.07 | 1.36 | 1.14 |
| temperature/humidity cycle | | | |
| μ₂ | | | |
| (in MPa) | | | |
| Variation (μ₂ − μ₀)/μ₀ | −17 | −28 | −17 |
| (in %) | | | |
| Stress at break after | 2.00 | 1.97 | 1.9 |
| temperature/humidity cycle | | | |
| τ₂ | | | |
| (in MPa) | | | |
| Variation (τ₂ − τ₀)/τ₀ | +17 | −10 | +4 |
| (in %) | | | |

### Example B (Comparative)

Example 1 is repeated with the sealant composition of example B which is indicated in table 1.

The results of the shear strength and tensile strength measurements are, respectively, collated in tables 2 and 3.

With regard to the shear strength of the assemblies made up of 2 substrates joined by the crosslinked sealant, it is noted that, unlike the results observed for example 1, the tests involving storage in boiling water and the temperature/humidity cycle have the effect of reducing the stress at break, for the 3 substrates tested.

The variations in stress at break induced by these tests involving storage show, compared to those of example 1, a decrease ranging:
from 11% to 18% for the test involving storage in boiling water; and
from 36% to 76% for the temperature/humidity cycle.

These results are indicative of a considerable deterioration in the solidity of the adhesive joint of example B compared to that of example 1, resulting from the corresponding tests involving storage.

With regard to the tensile strength of a test specimen made of the crosslinked sealant, it is observed for example B, that the effect of the tests involving storage on the modulus at 100% and the stress at break results in a very significant degradation of the mechanical properties of the crosslinked sealant, much greater than that observed for example 1.

### Example C (Comparative)

Example 1 is repeated with the sealant composition of example C which is indicated in table 1.

The results of the shear strength and tensile strength measurements are, respectively, collated in tables 2 and 3.

With regard to the shear strength of the assemblies made up of 2 substrates joined by the crosslinked sealant, a significant degradation of the stress at break is observed with the use of the sealant of example C comprising, as antioxidant, only a secondary diarylamine (C1), whether after a period in boiling water or after the temperature/humidity cycle, and for all the substrates tested. On the contrary, the use of the sealant of example 1 according to the invention results in an increase in the stress at break both for the test involving storage in boiling water and the temperature/humidity cycle test, for the 3 substrates tested.

With regard to the tensile strength of a test specimen made of the crosslinked sealant, it is noted that the change in the mechanical properties (stress at break and modulus at 100%) of the sealant of example C after the tests involving storage in boiling water and a temperature/humidity cycle is generally better compared to that observed for the sealant of example B, the sealant of example C even having an improvement in its mechanical properties after the temperature/humidity cycle, unlike the sealant of example B.

However, it is observed that the improvement in the mechanical properties of the sealant of example 1 according to the invention following the temperature/humidity cycle test is considerably greater than that observed for the sealant of example C, and the deterioration of these same properties after the test involving storage in boiling water is substantially smaller.

1-13. (canceled)

14. A sealant composition comprising, on the basis of the total weight thereof:
from 20% to 45% by weight of a silyl polymer (A);
from 30% to 55% by weight of a filler (B); and
from 0.05% to 5% by weight of an antioxidant composition (C) consisting:
of a secondary diarylamine (C1) of formula (1), (1′) or (1″): 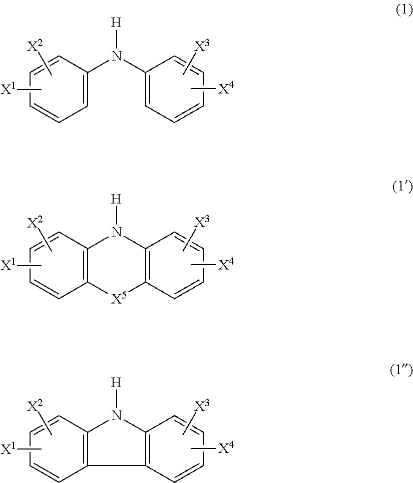
wherein:
X¹, X², X³ and X⁴, which are identical or different, each represent a hydrogen atom or a radical having from 1 to 20 carbon atoms and chosen from alkyl, arylalkyl, aryl and alkylaryl; it being possible in addition for X¹ and X² or X³ and X⁴ to be respectively engaged in a ring; and
X⁵ represents an oxygen or sulfur atom, or a —C(R)(R′)— divalent radical wherein R and R′, which are identical or different, are a hydrogen atom or an alkyl radical having from 1 to 30 carbon atoms; and
of a hindered phenol (C2) of formula (2): 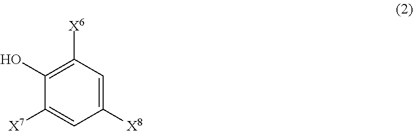
wherein:
X⁶ and X⁷, which are identical or different, represent a linear or branched alkyl radical comprising from 1 to 7 carbon atoms, and
X⁸ represents a linear, branched or cyclic alkyl radical comprising from 1 to 22 carbon atoms, with the optional presence of at least one heteroatom chosen from O or S or of a —COO— carbonyloxy function.

15. The sealant composition as claimed in claim 14, characterized in that the silyl polymer (A) is a polymer comprising at least one group of formula (I):
—Si(R⁴)ₚ(OR⁵)₃₋ₚ (I)
wherein:
R⁴ represents a linear or branched alkyl radical comprising from 1 to 4 carbon atoms, with the possibility that when there are several R⁴ radicals, these radicals are identical or different;
R⁵ represents a linear or branched alkyl radical comprising from 1 to 4 carbon atoms, with the possibility that when there are several R⁵ radicals, these radicals are identical or different, with the possibility that two OR⁵ groups may be engaged in the same ring; and
p is an integer equal to 0, 1 or 2.

16. The sealant composition as claimed in claim 14, characterized in that the silyl polymer (A) corresponds to one of the formulae (II), (III) or (IV): 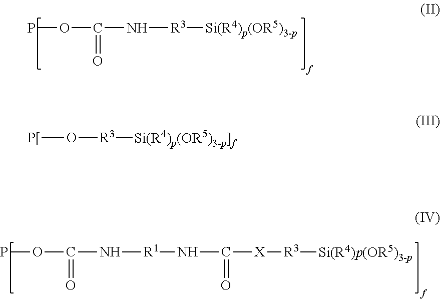
wherein:
R⁴, R⁵ and p have the same meaning as in formula (I) described above,
P represents a saturated or unsaturated, linear or branched polymeric radical optionally comprising one or more heteroatoms, and having a number-average molar mass ranging from 100 g/mol to 48600 g/mol,
R¹ represents a divalent hydrocarbon radical comprising from 5 to 15 carbon atoms which can be aromatic or aliphatic and linear, branched or cyclic,
R³ represents a linear or branched divalent alkylene radical comprising from 1 to 6 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms, and
f is an integer ranging from 1 to 6.

17. The sealant composition as claimed in claim 16, characterized in that the silyl polymer (A) corresponds to one of the formulae (II′), (III′) or (IV′): 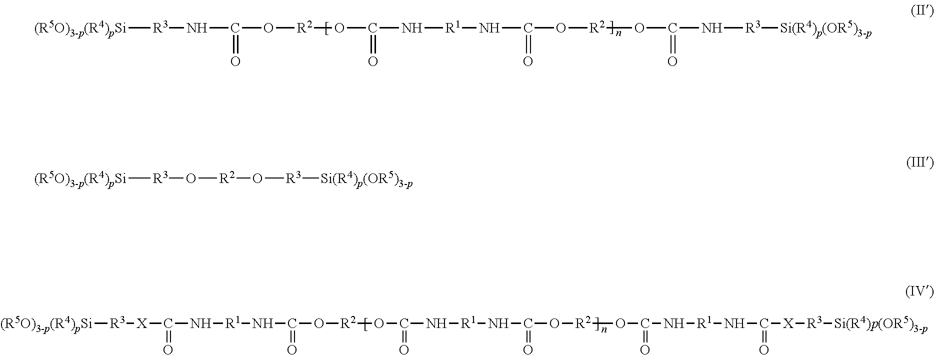
wherein:
R¹, R³, R⁴, R⁵, X, R⁷ and p have the same meaning as in formulae (II), (III) and (IV),
R² represents a saturated or unsaturated, linear or branched divalent hydrocarbon radical optionally comprising one or more heteroatoms, and having a number-average molar mass ranging from 100 g/mol to 48600 g/mol, and
n is an integer greater than or equal to 0.

18. The sealant composition as claimed in claim 17, characterized in that the silyl polymer (A) is a polymer of formula (IV′) wherein:
R¹ is the divalent radical derived from isophorone diisocyanate (IPDI)
R² is derived from a polypropylene glycol, and
X is the —NR⁷ radical.

19. The sealant composition as claimed in claim 14, characterized in that alkali metal or alkaline-earth metal carbonates are used as filler (B).

20. The sealant composition as claimed in claim 14, characterized in that the secondary diarylamine (C1) of formula (1), (1′) or (1″) is such that X² and X⁴ each represent a hydrogen atom and X¹ and X³ each represent an alkyl radical of 3 to 7 carbon atoms, substituted by a phenyl group.

21. The sealant composition as claimed in claim 14, characterized in that the hindered phenol (C2) of formula (2) is such that:
X⁶ and X⁷ represent a branched alkyl radical comprising from 3 to 4 carbon atoms, and
X⁸ represents an alkyl radical comprising from 10 to 22 carbon atoms and comprising a carbonyloxy group.

22. The sealant composition as claimed in claim 14, characterized in that the antioxidant composition (C) consists, on the basis of the total number of moles of (C1) and (C2), of 20% to 80% of (C1) and from 20% to 80% of (C2).

23. The sealant composition as claimed in claim 14, characterized in that the antioxidant composition (C) consists, on the basis of the total number of moles of (C1) and (C2), of 20% to 40% of (C1) and from 60% to 80% of (C2).

24. A process for assembling two substrates by adhesive bonding, comprising:
the coating, onto at least one of the two substrates to be assembled, of the sealant composition as defined in claim 14; then
effectively bringing the two substrates into contact.

25. The process as claimed in claim 24, characterized in that the substrates are chosen from inorganic substrates or organic substrates.

26. The process as claimed in claim 25, wherein the inorganic substrates comprise concrete, metals, or alloys.

27. The process as claimed in claim 25, wherein the organic substrates comprise wood or resins.
